(19) United States
(12) Patent Application Publication
(10) Pub. No.: US 2015/0149227 A1
(43) Pub. Date: May 28, 2015

(54) Providing a Task Notification Based on a Dynamic Attribute of an Entity

(71) Applicant: Google Inc., Mountain View, CA (US)

(72) Inventors: Erwin Can Sar, Mountain View, CA (US); Timothy Youngjin Sohn, Mountain View, CA (US); Andrew Tomkins, Menlo Park, CA (US)

(73) Assignee: Google Inc., Mountain View, CA (US)

(21) Appl. No.: 14/090,482

(22) Filed: Nov. 26, 2013

(51) Int. Cl. G06Q 10/06

(52) U.S. Cl. CPC G06Q 10/063114
USPC 705/7.15

(57) ABSTRACT

Methods and apparatus related to providing an indication to a user that a task may be completed based on the values of one or more dynamic attributes of an entity related to the task. An entity is determined based on information that is associated with the task. An indication related to completion of the task is provided to the user when the value of one or more dynamic attributes of the entity is one or more states.

### BACKGROUND

A user may have interest in creating one or more tasks and the user may utilize one or more applications to create the tasks. For example, a user may have interest in purchasing a product and a task may be created that includes information related to purchasing the product.

### SUMMARY

This specification is directed to methods and apparatus related to determining the satisfaction of one or more conditions based on the value of one or more dynamic attributes of an entity associated with a task and providing a notification to a user that the task may be completed based on satisfaction of the one or more conditions. The entity associated with the task may be determined based on task information related to the task. Some implementations of the specification are generally directed to identifying a task of a user, identifying task information related to the task, identifying at least one user attribute of the user, determining an entity associated with the task based on the task information and at least one user attribute, identifying a dynamic attribute of the entity, determining a condition state based on one or more values of the dynamic attribute that are indicative of likelihood that the user may have interest in completing the task, determining satisfaction of the condition based on comparison between the state and the value of the dynamic attribute, and providing an indication to the user related completion of the task when the condition has been satisfied. The dynamic attribute of the entity is an attribute that may change value independent of input from the user. The indication provided to the user may be, for example, a notification that the task may be completed or one or more task completion steps that may be performed by a user to complete the identified task.

In some implementations, a method is provided that includes the steps of: identifying a task of a user, wherein the task includes a task action and a task object; identifying task information related to the task; identifying at least one user attribute of the user; determining an entity associated with the task, wherein the entity is unique from the user, and wherein determining the entity is based on the task information and at least one of the user attributes; identifying a dynamic attribute of the entity, wherein a value of the dynamic attribute changes independent of input of the user; determining a condition for the task, wherein the condition is based on at least one state of the value of the dynamic attribute that indicates a likelihood that the user has interest in completing the task; determining a satisfaction of the condition, the satisfaction of the condition based on comparison of the state to the value of the dynamic attribute; and providing, in response to determining the satisfaction of the condition, an indication to the user related to completion of the task.

This method and other implementations of technology disclosed herein may each optionally include one or more of the following features.

The entity may be a person, the user attribute may be a user location, and the value of the dynamic attribute may be indicative of a distance between the user location and a location of the person. The state may be indicative of a threshold distance between the user location and the location of the person, and the step of determining the satisfaction of the condition may include determining that the distance satisfies the threshold distance.

In some implementations, the method may further include the step of determining a task completion step based on the task information, the task completion step being one or more actions that may be performed by the user, and the indication to the user may be the task completion step. In some of those implementations, the likelihood may be a low likelihood that the user has interest in completing the task, and the task completion step may include at least one of cancelling the task and rescheduling the task. In some of those implementations, the entity may be determined based on the task completion step. In some of those implementations, the user attribute may be one or more locations associated with the user, and the step of determining the task completion step may be based on the one or more locations. The entity may be determined based on the one or more locations.

The user attribute may be identified from latent information that is associated with the user. The user attribute may be based on at least one of browser history of the user, a location of the user, phone contacts of the user, calendar of the user, and email of the user.

The condition may be based on an event time when the user has interest in completing the task. The satisfaction of the condition may be based on the value of the dynamic attribute at the event time.

The entity may be determined based on at least one of the task action and the task object. The dynamic attribute may be identified based on the task information.

Other implementations may include a non-transitory computer readable storage medium storing instructions executable by a processor to perform a method such as one or more of the methods described herein. Yet another implementation may include a system including memory and one or more processors operable to execute instructions, stored in the memory, to perform a method such as one or more of the methods described herein.

Particular implementations of the subject matter described herein determine a condition for a task that is based on a dynamic attribute of an entity determined from the task. Particular implementations provide an indication to a user that the task may be completed based on satisfaction of the condition. The dynamic attribute may be identified based on one or more user attributes. The dynamic attribute and/or the condition of the task are new aspects of the task that may be determined for the task as described herein.

It should be appreciated that all combinations of the foregoing concepts and additional concepts discussed in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 is a block diagram of an example environment in which an indication that a task may be completed may be provided to a user based on one or more values of a dynamic attribute of an entity associated with the task.

FIG. 2 is an example illustration of a task and associated task completion steps.

FIG. 3 is an example illustration of entities and dynamic attributes of entities that may be determined based on task information and user attributes.

FIG. 4 is a flow chart illustrating an example method of providing an indication to a user that a task may be completed based on one or more dynamic attributes of an entity.

FIG. 5 is an example of an indication that a task may be completed.

FIG. 6 illustrates a block diagram of an example computer system.

### DETAILED DESCRIPTION

A user may have interest in completing a task and may utilize one or more applications to identify information that may be useful to completing the task. Additionally or alternatively, a user may have interest in creating a task, being provided with a notification that a task may be completed and/or being provided with a suggested task completion step at a time when the task may be completed. For example, a user may utilize a search engine to submit a search query of “Pay my taxes” and, based on the search query, a task may be created for the user to pay taxes. The task may include one or more task completion steps that may be utilized to pay taxes and the user may be provided with a notification to pay taxes on a particular date, such as a notification 2 weeks before the user's taxes are due. Also, for example, the user may be provided with one or more suggested task completion steps, such as a link to an online tax submission webpage, a link to one or more webpages that include tax forms, and/or a phone number to an accountant. The user may complete the task of “Pay my taxes” based on the provided one or more task completion steps.

In some instances, determining when a user may have interest in being provided with an indication related to completion of the task (e.g., an indication that a task may be completed and/or task completion step(s)) based on one or more dynamic attributes of an entity associated with the task. For example, a user may have interest in performing a task “when the weather is nice,” “when Bob is nearby,” and/or “when traffic isn't bad.” One or more dynamic attributes of entities that are related to a task may be determined and conditions for providing an indication to a user may be based on one or more particular values of the dynamic attributes. Dynamic attributes may include, for example, the location of a person, current cloud conditions, and/or current average speed on an interstate.

A task includes a task action and a task object that is associated with the task action. The task action may be an action that a user has interest in completing and/or having completed by one or more other users. For example, a task action may be “buy” and the user may have interest in buying something and/or having another person buy something for the user. A task object is an object that is associated with the task action. For example, a task may have a task action of “buy” and a task object of “bananas,” and the purpose of the task may be for the user to buy bananas. In some implementations, the task action and/or the task object of a task may include an entity identifier. An entity identifier may be associated with an entity in one or more databases, such as an entity database. In some implementations, a task action and/or a task object may include a textual representation of the task action and/or task object of the task. For example, a task may include the action “Buy,” and the task action of the task may include an identifier of an entity that is associated with the action “Buy” and/or may include the textual representation “Buy.”

In some implementations, a task may be associated with one or more task completion steps. A task completion step includes one or more completion actions and may include one or more completion objects. For example, a task completion step may be “Travel to the mall,” where the completion action is “travel” and the completion object is “mall.” In some implementations, a user may submit information via one or more applications; a task may be determined based on the information; and one or more task completion steps may be determined based on, for example, information that is associated with the user and/or the determined task, and/or additional information identified from one or more databases. For example, a user may submit a task of “Pay cell phone bill” and a task with a task action of “Pay” and a task object of “cell phone bill” may be determined based on the submitted tasks. The cellular phone provider of the user may be identified via additional information that is associated with the user, such as emails of the user, phone contacts of the user, and/or browsing history of the user. Additional information from an email may be utilized to associate a completion step of “Call 555-555-5555” with the task based on a billing department phone number of “555-555-5555” that was identified from an email from the identified cellular phone company of the user.

In some implementations, an indication related to completion of the task (e.g., completion steps for a task and/or a notification that a task may be completed) may be provided to the user when it is convenient for the user to complete the task and/or when it is likely that the user has interest in completion of the task at that time based on the satisfaction of one or more conditions. For example, a user may create an entry in a calendar application to “Contact Bob,” a task may be determined based on the entry, and a completion step of “Call 555-5555” may be determined based on identifying a contact number of “555-5555” for “Bob” in a contacts application of the user. In some implementations, the user may be provided with the task completion step of “Call 555-5555” and/or a notification to “Call Bob” on the date and/or at the time that the user has indicated in the calendar application to “Call Bob” and/or when the user utilizes a cellular phone and/or phone application. The task completion step may include populating a dialing application of the cellular phone with the phone number “555-5555” as a suggested task completion step. In some implementations, the user may be provided with a notification to “Contact Bob” based on satisfaction of one or more conditions and without a suggested completion step.

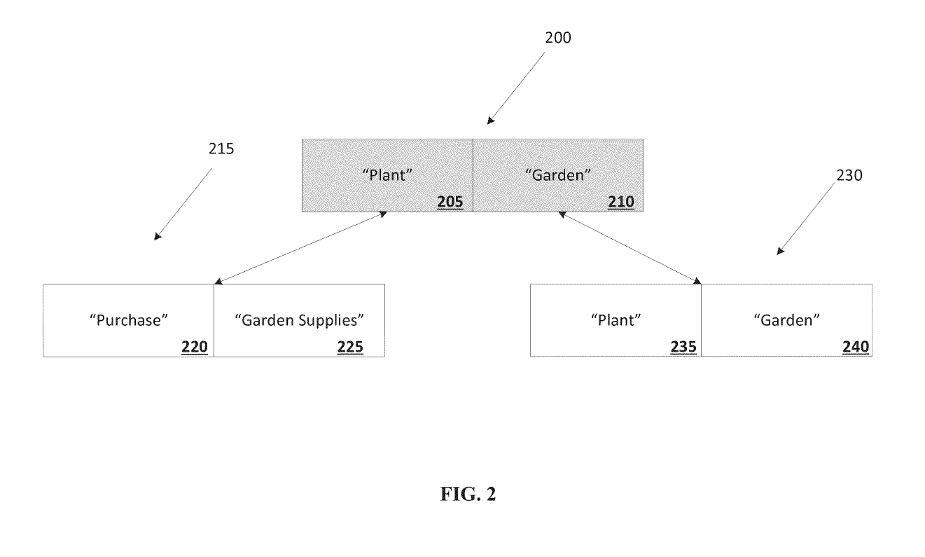

Referring to FIG. 2, an example of a task and associated task completion steps is provided. The task and/or task completion steps may be identified and/or determined based on, for example, one or more methods described herein. The task 200 includes a task action 205 of “Plant” and a task object 210 of “Garden.” In some implementations, task action 205 and/or task object 210 may be entity identifiers of one or more entities in a database. In some implementations, task action 205 and/or task object 210 may be textual representations of entities. Task 200 is associated with task completion step 215 and task completion step 230. A task completion step may be associated with a task based on, for example, explicit submission of a task completion step by a user, associating a task completion step of a similar task with the task based on the similarity between the tasks, and/or determining a task completion step based on additional information that is associated with the user (emails, contacts, browsing history, etc.). Task completion step 215 includes a completion action 220 of “Purchase” and a completion object 225 of “Garden Supplies” that may be utilized to provide a user with a task completion step related to purchasing garden supplies when one or more conditions have been satisfied. Task completion step 230 includes a completion action 235 of “Plant” and a completion object 240 of “Garden” that may be utilized to provide a user with a task completion step related to planting a garden. In some implementations, task action 205 and completion action 235 may be identifiers of the same entity in an entity database. Likewise, in some implementations, task object 210 and completion object 240 may be identifiers of the same entity.

In some implementations, an entity that is related to a task may be identified based on task information that is associated with the task and/or based on a user that is associated with the task. A task action entity, a task object entity, and/or entities that are associated with completion steps of a task may be utilized to identify one or more entities related to the task. For example, a task of “Plant my garden” may include a task object of “garden” and one or more entities that are related to a “garden” may be identified via an entity database. Also, for example, an entity that is associated with a task action of “Plant” may be identified in an entity database, and one or more additional entities that are associated with the “Plant” entity and the “garden” entity may be identified as entities that may be related to the task of planting a garden. For example, an entity associated with “weather,” an entity associated with “planting techniques,” and/or an entity associated with “garden store” may be identified as associated with the “plant” entity and/or the “garden” entity in an entity database.

In some instances, determining when to provide an indication to a user related to completion of a task may be based on one or more condition states. A condition state is one or more values of a dynamic attribute that are indicative of a likelihood that the user has interest in being provided an indication related to completing the task. For example, for a task of “Plant my garden when appropriate,” determining when planting a garden is appropriate may be contingent on the dynamic attributes of current weather conditions, previous weather conditions, and/or availability of appropriate plants at a gardening store. For example, a “weather” entity may be identified as related to a task of “Plant my garden” and the “weather” entity may include dynamic attributes of “temperature,” “rainfall,” and/or “cloud conditions” that may vary in value based location and/or anticipated conditions at a location. Also, for example, a “garden store” entity may include dynamic attributes of “plants in stock” and/or “operating hours” that may vary in value based on one or more factors that are controlled by the store.

Determining when to provide an indication related to completing the task may change based on values of the one or more dynamic attributes. For example, a user may be provided an indication to plant a garden when the temperature of the location of the user's garden has been above freezing for two weeks. Also, for example, a notification to plant a garden may be provided to a user when a gardening store has plants in stock that the user has indicated an interest in planting. An indication to plant a garden may not be appropriate until a value of one or more of the dynamic attributes of a task are indicative of an appropriate time to plant a garden.

In some implementations, one or more attributes of a user may be utilized to determine an entity with one or more dynamic attributes. For example, a user may be associated with one or more locations, such as a home address of the user, a work address of the user, and/or a current location of the user. Also, for example, a user may be associated with one or more personal contacts and/or one or more preferences that may be utilized to identify a dynamic attribute of an entity that may be utilized to determine a condition for providing an indication to complete a task.

In some implementations, determining when to provide an indication related to completion of a task may be based on one or more conditions that are determined based on a value of an identified dynamic attribute of an entity. For example, an entity associated with “weather” may be identified as related to a task of “Plant my garden” based on determining an association between the task action “plant,” the task object “garden,” and the “weather” entity. Also, for example, an entity associated with “weather at the user's location” may be identified based on a user attribute of a location of a user. In some implementations, the location of the user may be identified from latent information that is associated with the user and that is not explicitly provided by the user, such as emails of the user, user contacts, and/or an IP address of the user. The “weather at the user's location” entity may include dynamic attributes of “temperature,” “rainfall,” and/or “cloud conditions” and the values of the dynamic attributes may satisfy a condition to provide a user with an indication to plant a garden. The indication may not be provided to the user until the value of one or more of the dynamic attribute is one or more states that indicate likelihood that the user has interest in being provided the indication. For example, a notification to plant a garden may not be provided to a user until the value of a “temperature at the user's location” has been above freezing for at least two weeks. Additionally or alternatively, for example, an indication to plant a garden may not be provided to a user unless the value of a dynamic attribute of “rainfall at the user's location” has been within a certain range for the previous two weeks (i.e., the notification may not be provided if the location has experienced too much rain or too little rain over a time period).

In some implementations, an indication related to completion of the task may be provided to a user if a task is associated with a determined time and one or more dynamic attributes have values that are indicative of a low likelihood that the user will have interest in completing the task at that time. For example, a task of “have a picnic” may have a completion date of “next Sunday.” The task of “have a picnic” may have a condition that the task may be completed only if the values one or more dynamic attributes of an entity that is associated with the task are indicative of likelihood that the user has interest in performing the task. The user may be provided with an indication related to completion of the task that indicates the task may need to be cancelled and/or rescheduled if the values of the dynamic attributes are one or more states on the task completion date that indicate low likelihood that the user has interest in completing the task. For example, a task of “have a picnic” may have a completion date of “next Sunday” and the user may be provided with an indication to cancel the picnic if an entity associated with “weather at the picnic location” has a dynamic attribute of “rain prediction” with a value that indicates that rain is likely “next Sunday.”

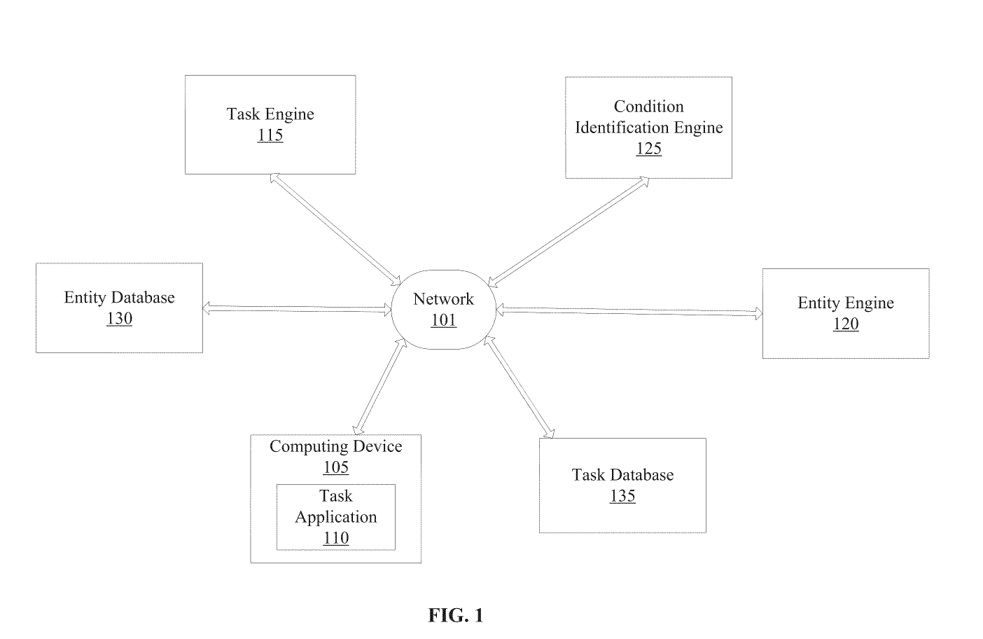

Referring to FIG. 1, a block diagram of an example environment is provided in which an indication that a task may be completed may be provided to a user based on one or more values of a dynamic attribute of an entity associated with the task. The environment includes a computing device 105 executing a task application 110, a task engine 115, an entity engine 120, a condition identification engine 125, an entity database 130, and a task database 135. The environment also includes a communication network 101 that enables communication between various components of the environment. In some implementations the communication network 101 may include the Internet, one or more intranets, and/or one or more bus subsystems. The communication network 101 may optionally utilize one or more standard communications technologies, protocols, and/or inter-process communication techniques.

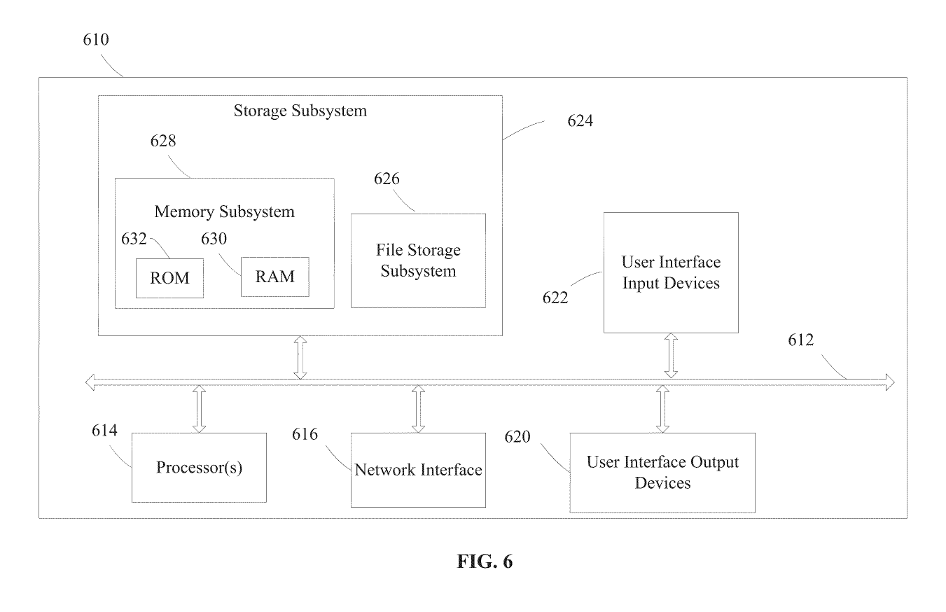

The computing device 105 executes one or more applications and may be, for example, a desktop computer, a laptop computer, a cellular phone, a smartphone, a personal digital assistant (PDA), a tablet computer, a navigation system, a wearable computing device (e.g., glasses, watch, earpiece), or another computing device. The computing device 105 includes memory for storage of data and software applications, a processor for accessing data and executing applications, and components that facilitate communication over a communication network 101. In some implementations, the computing device 105 may include hardware that shares one or more characteristics with the example computer system that is illustrated in FIG. 6. In some implementations, the one or more applications executed by the computing device 105 may include a task application 110. As discussed herein, the computing device 105 may optionally be utilized to, directly or indirectly, identify a user task of a user, provide user task information, and/or provide a user attribute to one or more components. The task application 110 may be utilized to access one or more applications such as, for example, e-mail applications, a calendar application, and/or a web browser executing on computing device 105. In some implementations, the task application 110 may be an application executing on computing device 105, such as a web browser and/or an add-on to one or more applications that are executing on computing device 105. In some implementations, the task application 110 may be an application that is dedicated to creating tasks. For example, a user may intend to create a task and the user may utilize task application 110 to directly submit information to create the intended task.

The task engine 115, entity engine 120, condition identification engine 125, and/or one or more additional components of the example environment of FIG. 1 may each include memory for storage of data and software applications, a processor for accessing data and executing applications, and components that facilitate communication over a network. In some implementations, task engine 115, entity engine 120, and/or condition identification engine 125 may include hardware that shares one or more characteristics with the example computer system that is illustrated in FIG. 6. The operations performed by components of the example environment may be distributed across multiple computer systems. For example, task engine 115, entity engine 120, and/or condition identification engine 125 may be computer programs running on one or more computers in one or more locations that are coupled to each other through a network.

In some implementations, task database 135 may be utilized by one or more components to store and/or access information. The task database 135 may include one or more storage mediums. For example, in some implementations, the task database 135 may include multiple computer servers each containing one or more storage mediums. Information described herein may optionally be stored in the task database 135 and/or an additional database. For example, tasks and associated information (e.g., task actions, task objects, completion steps, conditions to provide an indication to a user) may be stored in task database 135 for later access by one or more components. In this specification, the term “database” will be used broadly to refer to any collection of data. The data of the database does not need to be structured in any particular way, or structured at all, and it can be stored on storage devices in one or more locations. Thus, for example, the database may include multiple collections of data, each of which may be organized and accessed differently.

In some implementations, one or more of the tasks that are stored in task database 135 may be identified by task engine 115. In some implementations, task engine 115 may determine a task based on information that is received from task application 110. For example, task application 110 may identify information and/or one or more actions of a user and provide the information to task engine 115. Task engine 115 may create a task based on the provided actions of the user and/or additional information that was received from task application 110. Task engine 115 may store the determined task in task database 135 for later use and/or further utilize the task before storing the task in task database 135.

In some implementations, entity database 130 may be utilized to identify and/or store one or more entities that may include action entities and/or object entities of tasks and/or completion steps. For example, entity database 130 may include a mapping (e.g., data defining an association) between entities and one or more attributes and/or other related entities. In some implementations, entities are topics of discourse. In some implementations, entities are persons, places, concepts, and/or things that can be referred to by a textual representation (e.g., a term or phrase) and are distinguishable from one another (e.g., based on context). For example, the text “bush” in a query or on a webpage may potentially refer to multiple entities such as President George Herbert Walker Bush, President George Walker Bush, a shrub, and the rock band Bush. In some implementations, an entity may be referenced by a unique entity identifier that may be used to identify the entity. The unique entity identifier may be associated with one or more attributes associated with the entity and/or with other entities. For example, in some implementations, the entity database may include attributes associated with unique identifiers of one or more entities. For example, a unique identifier for the entity associated with the airport with an airport code “LAX” may be associated with a name or alias attribute of “LAX,” another alias attribute of “Los Angeles International Airport” (an alternative name by which LAX is often referenced), a phone number attribute, an address attribute, and/or an entity type attribute of “airport” in the entity database. Additional and/or alternative attributes may be associated with an entity in one or more databases.

In some implementations, task application 110 may provide task engine 115 with information that is associated with a user and/or actions of a user. Task engine 115 may determine a task for a user and/or task completion steps for a task based on the user information that is received from task application 110. For example, a user may submit a search query of “planting a garden” to a web browser and task application 110 may provide the search query to task engine 115. Task engine 115 may utilize the search query and/or one or more documents that were returned to the user as search results to determine a task of “plant a garden.”

Task engine 115 may identify one or more components of the task (e.g., task action and/or task object) and/or one or more components of task completion steps (e.g., completion action and/or completion object) that are associated with the task. For example, a task may be determined based on a user creating a calendar entry of “Meet Bob for lunch” in a calendar application and task engine 115 may identify a task action of “Meet” and task objects of “Bob” and “lunch” based on the terms of the calendar entry. In some implementations, the identified information that is associated with a task may be based on input of the user that is utilized to create the task. For example, task engine 115 may identify a task of “Call Bob” in task database 135 and identify a task action of “Call” and a task object of “Bob” for the task. Also, for example, task engine 115 may identify one or more entities in the entity database 130 that are associated with the task.

Task engine 115 may identify attributes that are associated with a user based on information that is provided by task application 110 and/or based on information in one or more databases. For example, task application 110 may provide information to task engine 115 that includes the location of the user when the user performed one or more actions. Also, for example, task application 110 may provide task engine 115 with additional information after a task has been determined. For example, task engine 115 may identify a task in task database 135 and user location information may be provided from task application 110 or another application at a later time. In some implementations, task engine 115 may identify user attributes based on one or more additional sources that are associated with the user, such as browser history of the user, one or more emails of the user, calendar application data, contacts from a contacts application of the user, and/or one or more documents that are associated with the user.

In situations in which the systems discussed herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, task engine 115 may determine one or more task completion steps to associate with a task. The task engine 115 may determine a task completion step based on information that is associated with a task. For example, task engine 115 may identify a task of “Buy bananas” and determine that a task completion step of “Go to the grocery store” may be an appropriate task completion step for the task based on identifying an association between “Buy bananas” and a completion step of going to a grocery store. Task engine 115 may determine a task completion step for a task based on identifying associations between one or more entities of a task and the task completion step in one or more database, such as entity database 130. Also, for example, task engine 115 may determine one or more task completion steps based on known task completion steps for other tasks that have been previously determined, such as one or more tasks in task database 135.

Task engine 115 may provide entity engine 120 with task information and entity engine 120 may identify one or more entities to associate with the task based on the task information. In some implementations, task engine 115 may provide a task to entity engine 120 that is already associated with one or more entities. For example, task engine 115 may determine a task action and task object for a task based on information that was provided by task application 110 and provide identifiers of entities to entity engine 120. Also, for example, task engine 115 may identify a task in task database 135 that has been previously associated with one or more entities and provide the task to entity engine 120 with the associated entities.

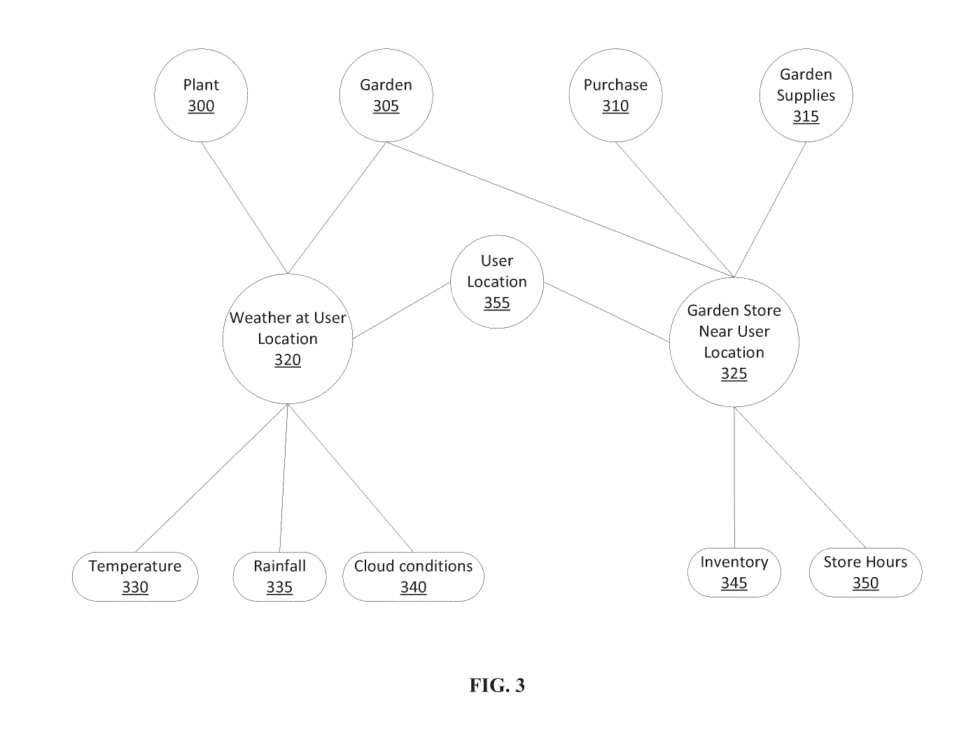

Referring to FIG. 3, a diagram of example entities and associations between the entities is provided. The provided diagram is an example of associations between the entities and the task and task completion steps of FIG. 2. Entity 300 corresponds to the task action 205 (“Plant”) and entity 305 corresponds to the task object 210 (“Garden”) of FIG. 2. The entity 310 corresponds to completion action 220 (“Purchase”) and entity 315 corresponds to completion object 225 (“Garden Supplies”). Task engine 115 may provide entity engine 120 with the task, including task information identifying the entities 300, 305, 310, and 315. Entity engine 120 may utilize the entities to determine one or more additional entities that may be associated with dynamic attributes that may be utilized to determine when to notify the associated user that the task may be completed. In the illustrated diagram, entity 320 (“Weather”) may be identified by task engine 115 based on identifying an association between entity 320 and entities associated with the action of planting (i.e., entity 300) and the object “garden” (i.e., entity 305). In some implementations, entity engine 120 may utilize information that is associated with a task completion step of a task to determine additional entities. For example, an entity associated with “Garden Store” (i.e., entity 325) may be identified by entity engine 120 based on identifying the associations between entity 325 and a “Purchase” entity 310 and “Garden Supplies” entity 315.

One or more of the entities that are identified by entity engine 120 may each be associated with one or more dynamic attributes. A dynamic attribute is an attribute that is associated with an entity and that may vary in value based on one or more factors. In some implementations, the variance of a dynamic attribute may reflect an aspect of an entity that is difficult to predict. For example, a “weather” entity may have a dynamic attribute of “current temperature” that may vary based on multiple uncontrollable weather phenomena, such as wind speed, air pressure, and current precipitation. Also, for example, a “traffic” entity may include a dynamic attribute of the “current average speed” on a street, and the average speed may vary based on weather conditions, current road construction, and/or road accidents that cannot be predicted with certainty.

In some implementations, entity engine 120 may identify one or more entities based on user attributes that have been provided. Task application 110 may identify one or more user attributes of a user based on information that is associated with the user and provide entity engine 120 with the user attributes. For example, an entity associated with “weather at the user's location” may be identified based on task information and additionally on a user location that is associated with a user. The user location may be identified by the task application based on, for example, emails of the user, a GPS component of computing device 105, and/or explicit input from the user.

Referring again to FIG. 3, the entities identified by entity engine 120 are further determined based on a “user location” user attribute 355. The dynamic attributes for the “weather” entity 320 include “temperature” attribute 330, “rainfall” attribute 335, and “cloud conditions” attribute 340. The dynamic attributes of the “garden store” entity 325 include an “inventory” attribute 345 and a “store hours” attribute 350. Based on the identified location of the user, entity engine 120 may determine a “weather at user location” entity 320 that includes dynamic attributes of the weather in the proximity of the “user location” user attribute 355. Also, for example, entity engine 120 may determine the “garden store near user location” entity 325 that is a store that is proximate to the “user location” user attribute 355. Additionally or alternatively, entity engine 120 may identify a “preferred store” user attribute for a user and determine a “preferred garden store” entity based on the identified user preference.

In some implementations, entity engine 120 may utilize one or more databases that include mapped information between one or more types of tasks and/or task completion step, and relevant dynamic attributes of entities that are associated with each type of task and/or task completion step. For example, an entity of “garden store” may be determined for a task with a task completion step of “purchase seeds.” The “garden store” entity may have dynamic attributes of “inventory” and “number of employees” and entity engine 120 may identify in one or more databases that a dynamic attribute of “number of employees” for a task with a task completion step related to “Purchase” is not relevant but a dynamic attribute of “inventory” is relevant for tasks with a task completion step with an action entity of “purchase.”

Condition identification engine 125 may determine one or more conditions that must be satisfied for an indication related to completion of a task to be provided to a user. One or more of the conditions may be satisfied when a value of a dynamic attribute of an entity that was identified by entity engine 120 is one or more states. Condition identification engine 125 may determine one or more states of values of the identified dynamic attributes will satisfy a condition to provide an indication related to completion of the task to the user. For example, for a task of “plant my garden,” entity engine 120 may determine an entity associated with the weather near the location of the user and condition identification engine 120 may determine that an indication related to planting a garden will be provided to the user based on the dynamic attributes of a weather entity. Referring again to FIG. 3, condition identification engine 125 may determine that the “temperature” attribute 330 must have a value above freezing for two weeks before a completion indication is provided to the user. Also, for example, condition identification engine 125 may determine that the “rainfall” attribute 335 must have a value that is less than 1 inch the last seven days before a completion indication is provided to the user.

In some implementations, condition identification engine 125 may determine one or more states for values of a dynamic attribute of an entity that will satisfy a condition to provide a completion indication to a user based on information that is identified from one or more additional sources. For example, condition identification engine 125 may identify information from a database that indicates what temperatures are appropriate for planting a garden and identify those values as states for a temperature attribute of an entity as conditions to provide an indication related to planting a garden to the user. Also, for example, condition identification engine 125 may identify information about appropriate values for a dynamic attribute based on information that is associated with a user. For example, condition identification engine 125 may be provided with information from one or more webpages that a user has visited and identify conditions for planting a garden based on the information from the webpages.

In some implementations, determining an entity that is associated with a task may include identifying a person that is not the user. For example, task application 110 may identify a person that is associated with a task of a user based on a user attribute of the user, such as a user attribute that is determined based from a contacts application and/or an email of the user. In some implementations, the task object and/or the completion object of a task may be a person, such as in the task of “Call Bob.” In some implementations, the dynamic attribute for a person entity may be based on the location of that person, which is not within the control of the user. Also, for example, the dynamic attribute for a person entity may be based on a distance between the user and the person, which is based on the user attribute of the location of the user. A task may include performing an action when the distance between the user and the person entity is a threshold distance. For example, a task may be “Call Bob when he gets to town” and a condition to provide an indication to the user that the task may be completed may be based on a dynamic attribute of “distance from Bob” being one or more states. For example, the user may be provided with an indication related to “Call Bob” when the value of the “distance from Bob” dynamic attribute is a state that is a threshold distance that is indicative of “Bob” being in the same general locale as the user, such as a 5 mile radius. Also, for example, a task may be “Have coffee with Bob tomorrow morning” and an indication related to completing the task may be provided to the user when a dynamic attribute of “distance from Bob” is a walking distance at the specified time (i.e., the morning).

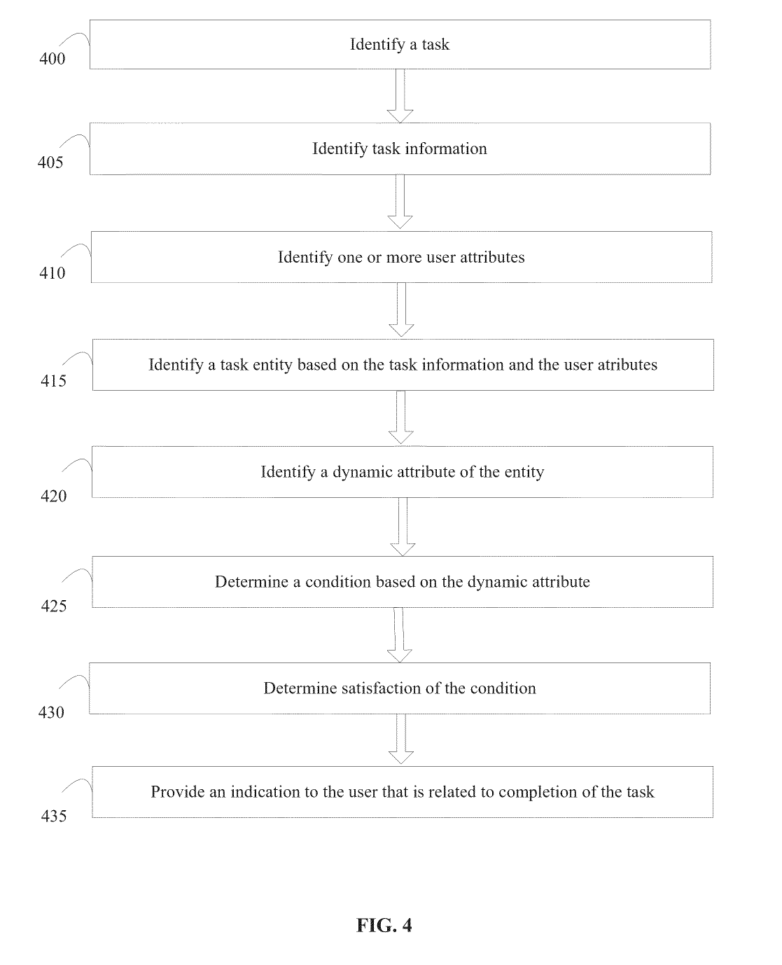

Referring to FIG. 4, a flow chart is provided illustrating an example method of providing an indication to a user that a task may be completed based on one or more dynamic attributes of an entity. Other implementations may perform the steps in a different order, omit certain steps, and/or perform different and/or additional steps than those illustrated in FIG. 4. The steps of the method illustrated in FIG. 4 may be performed by one or more components illustrated in FIG. 1.

At step 400, a task of a user is identified. In some implementations, the task is identified by a component that shares one or more characteristics with task engine 115. In some implementations, a task may be identified from a database that shares one or more characteristics with task database 135. In some implementations, one or more tasks may be determined by task engine 115 based on information that is provided to task engine 115 by a component that shares one or more characteristics with task application 110 via computing device 105. In some implementations, a task that is identified may be associated with one or more task completion steps. In some implementations, a task that is identified may not be associated with a task completion step.

At step 405, task information that is related to the task is identified. The task information may be identified by a component that shares one or more characteristics with task engine 115. In some implementations, task information may be identified based on one or more entities that are associated with the task. For example, a task may include a task object of “garden,” and task engine 115 may identify the task object “garden” as task information. In some implementations, task engine 115 may identify one or more entities in an entity database, such as an entity database 130, that are associated with an entity of a task. For example, task engine 115 may identify a “garden store” entity in entity database 130 that is associated with a task object “garden” entity of a task. In some implementations, task information may be provided by one or more applications based on additional information that is associated with the task. For example, task application 110 may identify one or more documents that are associated with the user and that may include task information, such as emails, entries in a calendar application, and/or browser history of the user.

At step 410, one or more user attributes are identified. In some implementations, user attributes may be identified by a component that shares one or more characteristics with task engine 115. In some implementations, user attributes may be identified based on information that is provided by task application 110. For example, task application 110 may provide task engine 115 with information that was identified from one or more sources that are associated with a user, such as emails, browser history, and/or calendar entries. Also, for example, task application 110 may identify one or more latent attributes of the user, such as user preferences; one or more locations that are associated with the user; and/or one or more contacts of the user based on one or more sources that are associated with the user.

At step 415, an entity that is associated with the task is identified based on the identified task information and the identified user attribute. An entity may be identified by a component that shares one or more characteristics with entity engine 120 and the entity may be identified via a database that shares one or more characteristics with entity database 135. In some implementations, the entity may be a component of the task, such as a task action or a task object. In some implementations, the entity may be a component of a task completion step that is associated with the task, such as a completion action or a completion object. In some implementations, the identified entity may be identified based on an entity that is associated with one or more entities that are components of a task. For example, a task may have a task action “plant” entity and an associated task completion step may have a task completion step of “Purchase seeds,” and entity engine 120 may identify a “garden store” entity that is associated with a task object “garden” entity, a completion action “purchase” entity, and/or a completion object “seeds” entity in an entity database 135.

At step 420, a dynamic attribute of the entity is identified. A dynamic attribute may be identified by a component that shares one or more characteristics with entity engine 120. A dynamic attribute is an attribute of the identified entity that has a varying value that may change independent of input from the user. For example, a “temperature” dynamic attribute may be associated with a “weather” entity and the “temperature” dynamic attribute may vary based on the current temperature at a location. Also, for example, a “location” dynamic attribute may be associated with a second user and the “location” dynamic attribute may vary based on the current location of the second user and/or the distance between the user and the second user. In some implementations, entity engine 120 may identify a value for a dynamic attribute via one or more databases that are updated with values for the dynamic attribute. For example, a “temperature” dynamic attribute may be identified via a database that includes temperature readings and that is updated as temperature varies. In some implementations, entity engine 120 may identify a value for a dynamic attribute via one or more additional sources. For example, entity engine 130 may identify a temperature value via a webpage that provides an updated reading for the temperature at a location.

At step 425, a condition for providing an indication to the user related to completing the task is determined. The condition may be based on a state of one or more values of the dynamic attribute that are indicative of a likelihood that the user has interest in completing the task. A condition for a task may be determined by a component that shares one or more characteristics with condition identification engine 125. In some implementations, one or more condition states may be identified via associations in entity database 135 and/or one or more additional databases. For example, a “garden” entity may have an “ideal planting temperature” attribute that has a value of “75 degrees.” The condition state may be based on a “temperature” dynamic attribute associated with a “garden” entity to having a value that is greater than 75 degrees. In some implementations, a condition state may be identified from one or more additional sources. For example, condition identification engine 125 may identify a webpage that includes information regarding ideal temperature values for planting a garden and condition identification engine 125 determine the condition state that is associated with a task of “plant garden” based on the identified value. In some implementations, the condition state for a task may be identified based on additional information that is associated with the task. For example, a task of “Plant garden” may be associated with the additional information “When it is not raining” based on additional information that was identified by task application 110. Condition identification engine 125 may determine a condition state for a “Current Weather” dynamic attribute of a “Weather” entity that is any value for the “Current Weather” dynamic attribute except for a value of “Raining.”

At step 430, satisfaction of the condition is determined based on the value of the dynamic attribute. A component that shares one or more characteristics with condition identification engine 125 may determine satisfaction of a condition by monitoring the dynamic attribute of the entity that was identified by entity engine 120. For example, entity engine 120 may identify an entity of “Weather” with a dynamic attribute of “Current temperature” and condition identification engine 125 may determine a source for identifying the current temperature, such as via one or more webpages that provide temperature information. In some implementations, a source for values of a dynamic attribute may provide a value to condition identification engine 125 on a periodic and/or asynchronous basis. For example, one or more sources and/or components may provide condition identification engine 125 with a value of a dynamic attribute every 10 minutes and/or each time the value of the dynamic attribute changes. In some implementations, a condition may be satisfied based on a dynamic attribute value that is indicative of low likelihood that the user has interest in completing the task.

At step 435, an indication that is related to completion of the task is provided to the user. In some implementations, an indication may be provided to the user via a computing device, such as computing device 105. In some implementations, one or more computing devices of a user may be provided with an indication. For example, a user may be provided with an indication that a task may be completed via a desktop computer and/or a mobile device. In some implementations, providing an indication that a task may be completed may include providing a user with a suggested completion step. For example, a dialing application of a mobile phone of a user may be populated with a phone number of “555-5555” for a suggested task completion step for a task of “Call Bob when his flight arrives” that is associated with a task completion step of “Call 555-5555” when a value that is associated with a dynamic attribute of “Flight Status” that is associated with a “Bob” entity indicates that a flight has arrived. In some implementations, a task completion step may be provided that includes one or more steps that may be performed by the user to cancel and/or reschedule the task based on a low likelihood that the user has interest in completing the task at an indicated time.

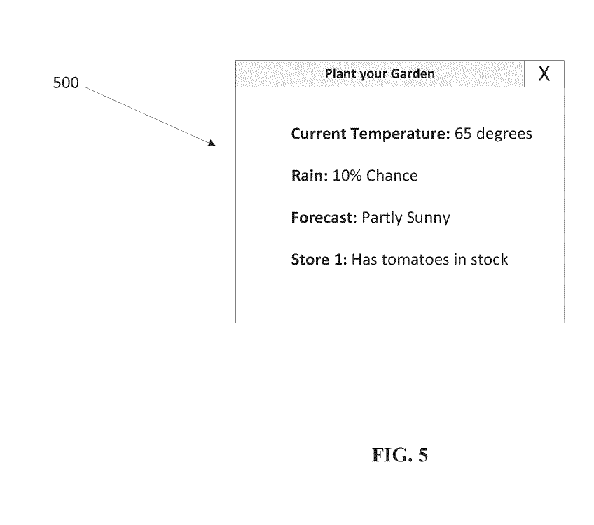

Referring to FIG. 5, an example of an indication that a task may be completed is provided. As described herein, task indication 500 may be provided in response to a value of a dynamic attribute of a determined entity that is related to a task. Task indication 500 may be provided to the user when the value of the dynamic attribute is a state that is indicative of interest in being provided task indication 500. Task indication 500 includes a display of the dynamic attributes that were utilized to determine the condition and current values for the dynamic attributes. For example, task indication 500 provides the user with an indication of the dynamic attribute “Current Temperature” and provides the user with the current value of the dynamic attribute, “65 degrees.” In some implementations, task indication 600 may suggest one or more completion steps to the user. For example, task indication 500 may include an indication of a suggested completion step of “Travel to Store 1” and/or provide the user with directions to Store 1 as a suggested completion step.

FIG. 6 is a block diagram of an example computer system 610. Computer system 610 typically includes at least one processor 614 which communicates with a number of peripheral devices via bus subsystem 612. These peripheral devices may include a storage subsystem 624, including, for example, a memory subsystem 626 and a file storage subsystem 628, user interface input devices 622, user interface output devices 620, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein. For example, the storage subsystem 624 may include the logic to identify a task of a user and provide an indication related to completion of a task based on a dynamic attribute of an associated entity.

These software modules are generally executed by processor 614 alone or in combination with other processors. Memory 626 used in the storage subsystem can include a number of memories including a main random access memory (RAM) 630 for storage of instructions and data during program execution and a read only memory (ROM) 632 in which fixed instructions are stored. A file storage subsystem 628 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 628 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple busses.

Computer system 610 can be of varying types including a workstation, server, computing cluster, blade server, server farm, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer implemented method, comprising:
identifying a task of a user, wherein the task includes a task action and a task object;
identifying task information related to the task;
identifying at least one user attribute of the user;
determining an entity associated with the task, wherein the entity is unique from the user, and wherein determining the entity is based on the task information and at least one of the user attributes;
identifying a dynamic attribute of the entity, wherein a value of the dynamic attribute changes independent of input of the user;
determining a condition for the task, wherein the condition is based on at least one state of the value of the dynamic attribute that indicates a likelihood that the user has interest in completing the task;
determining a satisfaction of the condition, the satisfaction of the condition based on comparison of the state to the value of the dynamic attribute; and
providing, in response to determining the satisfaction of the condition, an indication to the user related to completion of the task.

2. The method of claim 1, wherein the entity is a person, wherein the user attribute is a user location, and wherein the value of the dynamic attribute is indicative of a distance between the user location and a location of the person.

3. The method of claim 2, wherein the state is indicative of a threshold distance between the user location and the location of the person, and wherein determining the satisfaction of the condition includes determining that the distance satisfies the threshold distance.

4. The method of claim 1, further comprising determining a task completion step based on the task information, wherein the task completion step is one or more actions that may be performed by the user, and wherein the indication to the user is the task completion step.

5. The method of claim 4, wherein the likelihood is a low likelihood that the user has interest in completing the task, and wherein the task completion step includes at least one of cancelling the task and rescheduling the task.

6. The method of claim 4, wherein determining the entity is based on the task completion step.

7. The method of claim 4, wherein the user attribute is one or more locations associated with the user, and wherein determining the task completion step is based on the one or more locations.

8. The method of claim 7, wherein determining the entity is based on the one or more locations.

9. The method of claim 1, wherein the user attribute is identified from latent information that is associated with the user.

10. The method of claim 9, wherein the user attribute is based on at least one of browser history of the user, a location of the user, phone contacts of the user, calendar of the user, and email of the user.

11. The method of claim 1, wherein the condition is based on an event time when the user has interest in completing the task.

12. The method of claim 11, wherein satisfaction of the condition is based on the value of the dynamic attribute at the event time.

13. The method of claim 1, wherein the entity is determined based on at least one of the task action and the task object.

14. The method of claim 1, wherein the dynamic attribute is identified based on the task information.

15. A system including memory and one or more processors operable to execute instructions in memory, comprising instructions to:
identify a task of a user, wherein the task includes a task action and a task object;
identify task information related to the task;
identify at least one user attribute of the user;
determine an entity associated with the task, wherein the entity is unique from the user, and wherein determining the entity is based on the task information and at least one of the user attributes;
identify a dynamic attribute of the entity, wherein a value of the dynamic attribute changes independent of input of the user;
determine a condition for the task, wherein the condition is based on at least one state of the value of the dynamic attribute that indicates a likelihood that the user has interest in completing the task;
determine a satisfaction of the condition, the satisfaction of the condition based on comparison of the state to the value of the dynamic attribute; and
provide, in response to determining the satisfaction of the condition, an indication to the user related to completion of the task.

16. The system of claim 15, wherein the entity is a person, wherein the user attribute is a user location, and wherein the value of the dynamic attribute is indicative of a distance between the user location and a location of the person.

17. The system of claim 16, wherein the state is indicative of a threshold distance between the user location and the location of the person, and wherein the instruction to determine the satisfaction of the condition includes the step of determining that the distance satisfies the threshold distance.

18. The system of claim 15, wherein the instructions further include instructions to: determine a task completion step based on the task information, wherein the task completion step is one or more actions that may be performed by the user, and wherein the indication to the user is the task completion step.

19. The system of claim 18, wherein the likelihood is a low likelihood that the user has interest in completing the task, and wherein the task completion step includes at least one of cancelling the task and rescheduling the task.

20. The system of claim 18, wherein the user attribute is one or more locations associated with the user, and wherein the task completion step is determined based on the one or more locations.

21. The system of claim 15, wherein the user attribute is identified from latent information that is associated with the user.

22. The system of claim 15, wherein the condition is based on an event time when the user has interest in completing the task.

23. The system of claim 22, wherein satisfaction of the condition is based on the value of the dynamic attribute at the event time.

24. A non-transitory computer readable storage medium storing at least one program configured for execution by at least one processor of a computer system, the at least one program comprising instructions to:
identify a task of a user, wherein the task includes a task action and a task object;
identify task information related to the task;
identify at least one user attribute of the user;
determine an entity associated with the task, wherein the entity is unique from the user, and wherein determining the entity is based on the task information and at least one of the user attributes;
identify a dynamic attribute of the entity, wherein a value of the dynamic attribute changes independent of input of the user;
determine a condition for the task, wherein the condition is based on at least one state of the value of the dynamic attribute that indicates a likelihood that the user has interest in completing the task;
determine a satisfaction of the condition, the satisfaction of the condition based on comparison of the state to the value of the dynamic attribute; and
provide, in response to determining the satisfaction of the condition, an indication to the user related to completion of the task.
